(19) United States
(12) Patent Application Publication
(10) Pub. No.: US 2010/0264099 A1
(43) Pub. Date: Oct. 21, 2010

(54) SEPARATION DEVICE COMPRISING A PHYSICAL BARRIER

(75) Inventors: Peter Warthoe, Copenhagen O (DK); Per Berdén, Malmo (SE)

Correspondence Address: THE NATH LAW GROUP, 112 South West Street, Alexandria, VA, 22314, US

(73) Assignee: ATONOMICS A/S, Copenhagen SV (DK)

(21) Appl. No.: 12/742,386

(22) PCT Filed: Nov. 26, 2007
(86) PCT No.: PCT/DK07/00516

§ 371 Date: May 11, 2010

(51) Int. Cl. B01D 35/28; B01D 37/00

(52) U.S. Cl. 210/806; 210/435; 210/767

(57) ABSTRACT

The present invention relates to a device for separating a suspension into a liquid phase and a retentate phase. The device comprises a separation chamber comprising an application zone and a hydrophilic filter material. The separation chamber is connected to a first capillary channel, where the connecting junction between the separation chamber and the first capillary channel comprise a physical barrier preventing flow of residue retentate from a lower part of the chamber into the first capillary channel. The invention further relates to a method for separating a liquid sample consisting of less than 200 μl suspension, into a retentate phase comprising the suspended matter, and a liquid phase substantially free of suspended matter.

### TECHNICAL FIELD

The present invention relates to a device for separating a suspension into a liquid phase and a retentate phase and to the use thereof.

The invention further relates to a method for separating a liquid sample consisting of less than 200 μl suspension, into a retentate phase comprising the suspended matter, and a liquid phase substantially free of suspended matter. The suspension might be blood, the liquid phase plasma/serum and the retentate blood cells.

### BACKGROUND

Many diagnostics are carried out in the clinical field utilizing blood as a sample. Although some of these techniques can be carried out on whole blood, it is necessary in many instances to utilize serum or plasma as the sample in order to obtain an accurate reading. For example, red blood cells (erythrocytes) scatter and absorb light and could adversely affect a measurement of either reflected or transmitted light of a diagnostic test relying on either of these measurement techniques.

Traditionally, plasma and serum have been separated from whole blood by centrifuging either before (for plasma) or after (for serum) clotting. However, centrifugation is time consuming and requires equipment that is not generally available outside the clinical laboratory. Accordingly, field testing of numerous blood substances that require serum or plasma is difficult.

A number of techniques have been devised to avoid this problem. The techniques generally utilize a filtering device capable of separating red blood cells from plasma. Numerous materials have been used in the past to form filters. Paper, non-woven fabric, sheet-like filter material composed of powders or fibers such as man-made fibers or glass fibers, and membrane filters having suitable pore sizes have been proposed.

However, these prior art techniques have proven to be unsuitable for use in applications which, because of space and volume restraints, can only utilize a small filter in a device in which a single drop of blood is separated and the plasma is transported through the device solely by means of capillary action. Thus, most prior art devices for separation suffers from dealing with sufficient to separate undiluted whole-blood by use of capillary and/or hydrostatic pressure without the use of an external force. Accordingly, further refinement in blood separation techniques is desirable.

Accordingly one object of the present invention was to develop a device and a method capable to separate undiluted whole-blood into a plasma/serum phase and a blood cell phase in a short time, where the plasma/serum phase is substantially free of blood cell contamination, and wherein the blood sample comprises less than 200 μL.

Another object of the invention was to develop a device and a method capable to separate undiluted whole-blood into a plasma/serum phase and a blood cell phase in short time, where the separation is driven without the use of an external force, and wherein the blood sample comprises less than 200 μL.

### DISCLOSURE OF THE INVENTION

An object of the invention was to develop a device and a method capable to separate a suspension into a liquid phase and a retentate phase in a short time, where the liquid phase is substantially free of retentate contamination.

A further object was to develop a device and a method capable to separate a suspension into a liquid phase and a retentate phase in a short time where the separation is driven without the use of an external force.

This was achieved by the device according to the invention.

Accordingly, in one embodiment the invention relates to a device for separating a suspension comprising 200 μl or less into a liquid phase and a retentate phase, the device comprises a separation chamber (2) comprising an application zone (1) and a hydrophilic filter material (17), said separation chamber being connected to a first capillary channel (3), where the connecting junction between the separation chamber and the first capillary channel comprise a physical barrier (10) preventing flow of residue retentate from a lower part of the chamber into the first capillary channel.

In a preferred aspect the sample to be analysed preferably has a volume of less than 200 μl. In an even more preferred aspect the sample to be analysed has a volume of less than 150 μl, even more preferred less than 100 μl, even more preferred less than 90 μl, such as less than 80 μl, less than 70 μl or even less than 60 μl. In an even more preferred aspect the sample to be analysed has a volume of less than 50 μl, even more preferred less than 45 μl, even more preferred less than 40 μl.

In a preferred aspect the first part of the capillary channel has a volume of less than 100 μl. In an even more preferred aspect the capillary channel has a volume of less than 90 μl, even more preferred less than 80 μl, even more preferred less than 70 μl, such as less than 60 μl, less than 50 μl or even less than 40 μl. In an even more preferred aspect the first part of the Capillary channel has a volume of less than 30 μl, even more preferred less than 25 μl, even more preferred less than 20 μl, such as less than 15 μl, less than 10 μl or even less than 5 μl.

In another embodiment at least the lower part of the internal surface of the first capillary channel facing the liquid is made of a surface treated plastic material. The surface treatment may be an oxidation, preferably a corona treatment.

In an further embodiment the device comprises an upper part and a lower part, where the two parts when assembled form a separation chamber (2), a first capillary channel (3), and a physical barrier (10) preventing flow of residue retentate from a lower part of the chamber into the first capillary channel, said upper part having an application well (1) leading to the separation chamber.

In another embodiment the device further comprise a prefilter material (15).

In a further aspect the invention relates to the use of the device according to the invention for separating a suspension comprising 200 μl or less into a liquid phase and a retentate phase, where the liquid phase is substantially free of suspended matter. The suspension might be blood, the liquid phase plasma/serum and the retentate blood cells.

In a further aspect the invention relates to a method for separating a liquid sample consisting of less than 200 μl suspension, into a retentate phase comprising the suspended matter, and a liquid phase substantially free of suspended matter; the method comprising the steps of:
a. optionally applying a suspension to a prefilter and leading the suspension through the prefilter for the retention of suspended matter and substantially uniform transfer the liquid to the filter material of step b;
b. applying less than 200 μl of a sample suspension, or the liquid of step a., to a filter material;
c. applying the filter material comprising the suspension to a separation chamber, which is connected to a first capillary channel;
d. over saturating the filter to feed the first capillary channel;
e. preventing flow of residue retentate from the lower part of the separation chamber into the first capillary channel, thereby sedimenting the suspended matter on the lower part of the of the separation chamber to separate the suspension into a retentate phase and a liquid phase; and
f. directing the liquid phase into the first capillary channel.

In a further aspect of the method the liquid phase is directed into the first capillary channel solely by the combined action of capillary forces provided by the first capillary channel and hydrostatic pressure generated by the applied sample.

### BRIEF DESCRIPTION OF THE DRAWINGS

The invention is explained in detail below with reference to the drawings, in which

FIG. 1 illustrates a schematic presentation of a sample device comprising a microfluid channel having three chambers (3, 5, 6), an application zone (1), a separation chamber (2), a first capillary channel (3), a collection chamber (4a), a waste outlet (4b), a washing chamber (5), a detection chamber (6), magnetic particles location in washing chamber (7), an inlet channel for washing and detector solution (8), a physical barrier (10 (vertical), 10′ (incline)) between the separation chamber and the first capillary channel, capillary micro channels (11) in the first capillary channel (3), corona treatment (12) (symbolised by the grey shade) of the first capillary channel, and a detector unit (14).

FIG. 2 illustrates the same principle as in FIG. 1 with a three dimension illustration.

A sample device comprising a microfluid channel having three chambers (3, 5, 6), an application well (1′), a separation chamber (2), a hydrophilic filter material (17) for blood filtration, a first capillary channel (3), a collection chamber (4a), a waste outlet (4b), a washing chamber (5), a detection chamber (6), magnetic particles location in washing chamber (7), an inlet channel for washing and detector solution (8), a physical barrier (10, 10′) between the separation chamber and the first capillary channel (3), capillary micro channels (11) in the first capillary channel (3), corona treatment (12) of the first capillary channel (3) and a detector unit (14).

FIG. 3 illustrates a schematic site view of a separation device comprising a microfluid channel (3), an application well (1′), a separation chamber (2), a first capillary channel (3), a physical barrier (10′) between the separation chamber and the first capillary channel, a hydrophilic filter material (17), and a prefilter (15).

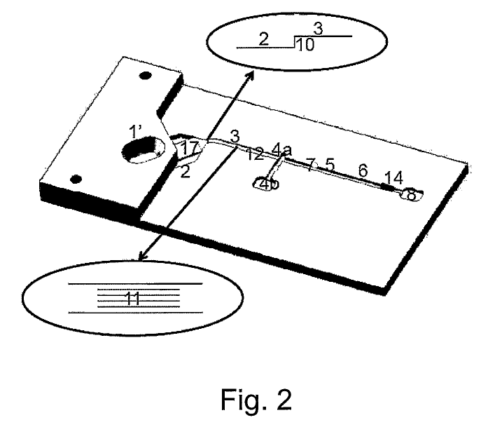

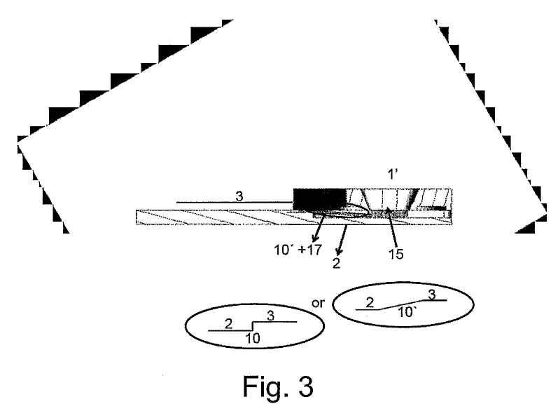

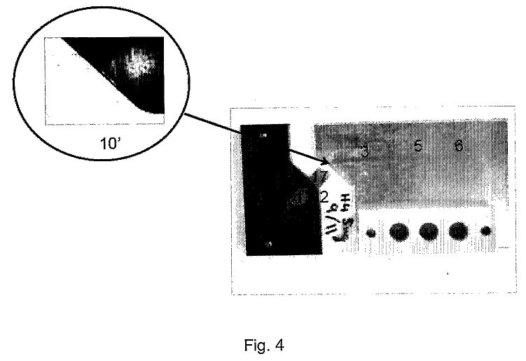

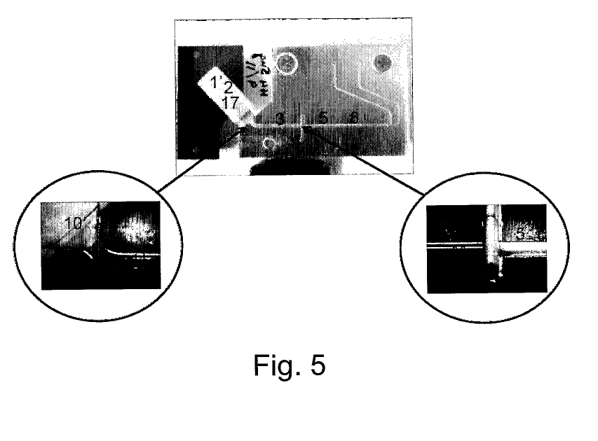

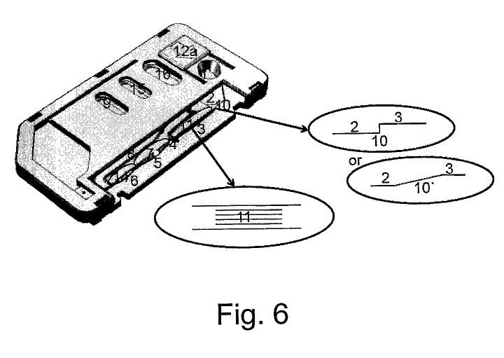

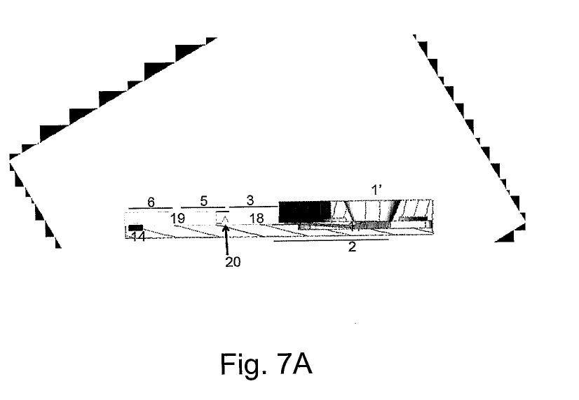

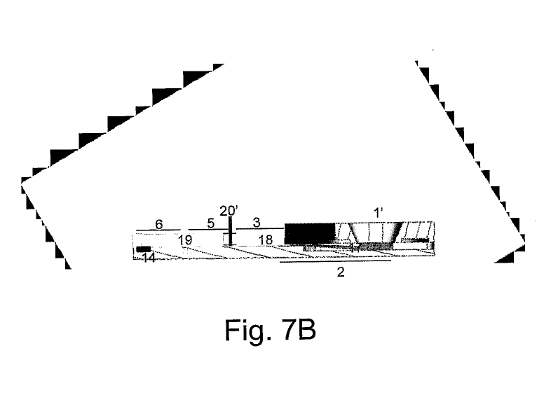

FIG. 4 illustrates a prototype picture of FIG. 2 presentation of a separation device comprising a microfluid channel having three chambers (3, 5, 6), a application well (1′), a separation chamber (2), a first capillary channel (3), a washing chamber (5), a detection chamber (6), a physical barrier (10′) between the separation chamber and the first capillary channel, and a hydrophilic filter (17).

FIG. 5 illustrates a prototype picture of FIG. 4 (backside), presentation of an integrated separation and detection device comprising a microfluid channel having three chambers (3, 5, 6), an application well (1′) backside, a separation chamber (2) backside, a first capillary channel (3), a washing chamber (5), a detection chamber (6), a physical barrier (10′) between the separation chamber and the first capillary channel, and a hydrophilic filter (17). Left circle is a magnified view of the physical barrier (10′) between the separation chamber and the first capillary channel in order to illustrate the capillary microchannels (11) in the first capillary channel. Right circle is a magnified view of the first capillary channel at the collection chamber in order to illustrate the capillary microchannels.

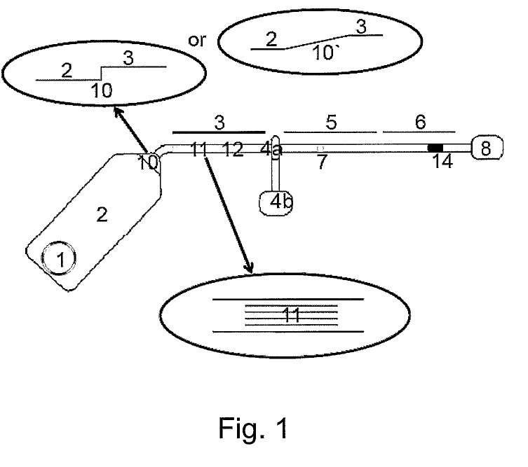

FIG. 6 illustrates same principle as in FIG. 1 with a three dimension illustration including more features. A integrated separation and detection device comprising a microfluid channel having three chambers (3, 5, 6), an application well (1′), a separation chamber (2), a first capillary channel (3), a collection chamber (4a), a waste outlet (4b), a washing chamber (5), a detection chamber (6), magnetic particles location in washing chamber (7), an inlet channel for washing and detector solution (8), a physical barrier (10, 10′) between the separation chamber and the first capillary channel, capillary micro channels (11) in the first capillary channel (3), a detector unit (14), a first compartment for detection solution A (9), a second compartment for detection solution B (15), a washing solution compartment (16), and a blood lid (12a).

FIG. 7a illustrates a schematic site view of an integrated separation and detection device comprising a microfluid channel (3,5,6), an application well (1), a separation chamber (2) and the hydrophilic filter (17), a first capillary channel (3), serum/plasma (18) in the first capillary channel, signal solution (19) in washing (5) and detector chamber (6), light trap version A (20) in connecting junction between the first capillary channel (3) and the washing chamber (5), and a detector unit (14).

FIG. 7b illustrates a schematic site view of an integrated separation and detection device comprising a microfluid channel (3,5,6), a application well (1), a separation chamber (2) and hydrophilic filter (17), a first capillary channel (3), serum/plasma (18) in the first capillary channel, signal solution (19) in washing (5) and detector chamber (6), a light trap version B (20′) in connecting junction between the first capillary channel (3) and the washing chamber (5), and a detector unit (14).

### DEFINITIONS

In the context of the present invention, by “capillary channel” is meant a narrow tube or channel through which a fluid can pass. Preferably the diameter of a first capillary channel according to the invention is less than 10 mm. Even more preferred the diameter of a first capillary channel according to the invention is less than 5 mm, such as less than 4 mm, or less than 3 mm or even less than 2 mm. In a most preferred aspect the first capillary channel has a diameter of 1 mm or less, e.g. 0.2-1.0 mm.

In the context of the present invention, by “lower part” is meant the part of a device when in use, which is closest to the center of the earth. By “upper” is meant the opposite, namely, the part furthest away from the center of the earth when in use. Accordingly, a liquid would lie on the lower part and not the upper part when in use.

### DETAILED DESCRIPTION OF THE INVENTION

One useful aspect of the invention is that separation of red blood cells from plasma can be accomplished utilizing a single layer of filter material and a small volume of blood. Prior art materials used for blood separation on a larger scale and/or utilizing multiple-layer filters with absorbent layers have proven not to be useful under the present conditions for separation.

Therefore a device and a method was developed which is capable of separating whole-blood into a plasma/serum phase and a retentate phase (blood cells) in a short time, where the liquid phase is substantially free of retentate contamination, and where the separation is driven without the use of an external force.

Accordingly, in one embodiment the device for separating a suspension comprising 200 μl or less into a liquid phase and a retentate phase comprises a separation chamber (2) comprising a hydrophilic filter material (17), said separation chamber being connected to a first capillary channel (3), where the connecting junction between the separation chamber and the first capillary channel comprise a physical barrier (10, 10′) preventing flow of residue retentate from a lower part of the chamber into the first capillary channel.

The presence of this physical barrier was surprisingly shown to create a substantially improved separation of the fluid material from the suspended matter. Accordingly, by visual inspection, it was observed that blood samples applied to the device without the physical barrier created a light red coloured fluid in the first capillary channel. However, when the connecting junction between the separation chamber and the first capillary channel comprised a physical barrier preventing flow of residue retentate from a lower part of the chamber into the first capillary channel, by visual inspection, it was observed that blood samples applied to the device created a transparent uncoloured fluid in the first capillary channel.

In one embodiment the physical barrier is in the form of a vertical barrier having a height (10) of at least 0.2-1.6 mm.

In a further embodiment the height of the barrier is at least 0.8-1.6 mm.

In a further embodiment the physical barrier (10) in the horizontal plane and in the direction towards the first capillary channel describes an incline extending from the bottom of the separation chamber.

In a further embodiment the incline in vertical direction is 0.2-1.6 mm, and in horizontal direction 0-100% of the length of the first capillary channel.

In a further embodiment the incline in vertical direction is about 0.8-1.6 mm, and in horizontal direction about 20-80% of the length of the first capillary channel.

In a further embodiment at least the lower part of the internal surface of the first capillary channel facing the liquid is made of a surface treated plastic material.

In a further embodiment the stable plastic material is polystyrene, polymethylmethacrylate, polyethylene, polypropylene, polyacrylates, silicon elastomers or the like.

In a further embodiment the surface treatment is an oxidation. In a further embodiment the oxidation is a corona treatment. Especially when at least the lower part of the internal surface of the first capillary channel facing the liquid is made of a corona treated plastic surface, it was observed by visual inspection that the capillary channel was very efficient in pulling the liquid into the capillary channel.

In a further embodiment the device further comprises a collecting chamber (4a) connected to the first capillary channel.

In a further embodiment the device comprises an upper part and a lower part, where the two parts when assembled form a separation chamber (2), a first capillary channel (3), and a physical barrier (10) preventing flow of residue retentate from a lower part of the chamber into the first capillary channel, said upper part having an inlet leading to the separation chamber. By having to parts the device is more easy to use and clean etc.

In a further embodiment the interfaces between the upper and lower parts are sealed with a hydrophobic sealant.

In a further embodiment the device further comprise a prefilter material (15).

In a further embodiment the width and height of the first capillary channel is 0.25-2.0 mm and 0.2-1.0 mm, respectively.

In a further embodiment the length of the first capillary channel from the outlet of the separation chamber to the inlet of collection chamber is 5-20 mm.

In a further aspect the invention relates to the use of a device for separating a suspension comprising 200 μl or less into a liquid phase and a retentate phase, where the liquid phase is substantially free of suspended matter.

In a further aspect the suspension is blood.

In a further aspect the invention relates to a method for separating a liquid sample consisting of less than 200 μl suspension, into a retentate phase comprising the suspended matter, and a liquid phase substantially free of suspended matter; the method comprising the steps of:
a. optionally applying a suspension to a prefilter and leading the suspension through the prefilter for the retention of suspended matter and substantially uniform transfer the liquid to the filter material of step b;
b. applying less than 200 μl of a sample suspension, or the liquid of step a., to a filter material;
c. applying the filter material comprising the suspension to a separation chamber, which is connected to a first capillary channel;
d. over saturating the filter to feed the first capillary channel;
e. preventing flow of residue retentate from the lower part of the separation chamber into the first capillary channel, thereby sedimenting the suspended matter on the lower part of the of the separation chamber to separate the suspension into a retentate phase and a liquid phase; and
f. directing the liquid phase into the first capillary channel.

In a further aspect the liquid phase is directed into the first capillary channel solely by the combined action of capillary forces provided by the first capillary channel and hydrostatic pressure generated by the applied sample.

In a further aspect the first capillary channel is regarding to dimensions defined as above.

In a further aspect the blood is human blood.

### EXAMPLE

### Investigation of Presence of Physical Barrier, Corona Treatment and Micro Channels on the Separation into Clear Plasma in Collection Channel Using Blood Filtration Device

### Conclusions

Presence of a physical barrier (10,) at the connecting junction between the separation chamber and the first capillary channel, preventing flow of residue retentate from a lower part of the chamber into the first capillary channel, result in an improved separation of the liquid and the suspended matter.

The corona treatment of at least the lower part of the internal surface of the first capillary channel facing the liquid, significantly enhances the filling of the collection chamber with plasma.

The use of micro channels in at least the lower part of the internal surface of the first capillary channel facing the liquid is made of a surface treated plastic decreases the filling time significantly.

### Experimental Setup

The blood filtration device used for the experiments was the milled K2 cartridge in clear polystyrene as illustrated in FIG. 2, with capillary stop and hydrophobic film covering the milled channels. The K2 blood inlet was used with oval 5×7.5 mm pre-filter (vertical flow filter VF1, Whatman). The lateral flow filter 4×15 mm (Fusion 5, Whatman) was mounted on a hydrophobic adhesive. 100 μl K₃EDTA stabilized human blood (2 weeks old) was used for each experiment.

The volume of the collection chamber was 4.6 μl for the K2 device with the 3 micro channels

(≈0.15×0.15 mm).

The volume of the collection channel was measured by slowly filling it with indicator solution with a 1-10 μl pipette.

The investigation was done using K2 cartridge as illustrated in FIG. 2 with and without the micro channels. For both setups the filling time of collection chamber for non corona treated and corona treated cartridges was measured.

### Results

Preliminary investigations on the presence or absence of the physical barrier at the connecting junction between the separation chamber and the first capillary channel, preventing flow of residue retentate from a lower part of the chamber into the first capillary channel, showed an improved separation of the liquid and the suspended matter when the barrier was present.

Further investigations on the capillary channels produced the following results:

The volume of the collection chamber without the micro channels was measured to 3.1 μl. The volume of collection chamber including the micro channels was 4.6 μl.

| Corona treatment | Micro channels | Filling time (3.1 μl) |
|---|---|---|
| No | No | Did not fill (5% after 12 min, plasma |
| | | is accumulated at the tip of the filter |
| | | but does not fully enter the collection |
| | | chamber) |
| No | Yes | Did not fill (5% after 12 min, plasma |
| | | is accumulated at the tip of the filter |
| | | but does not fully enter the collection |
| | | chamber) |
| Yes | No | 3.6 min |
| Yes | Yes | 2.6 min |

### Discussion

The results in the table above show it is very beneficial to corona treat the collection chamber in order to get it sufficiently hydrophilic and filled with plasma by capillary force. Note this is under the circumstances using hydrophobic film covering the milled channels.

The table also shows a shorter filling time by the use of capillary micro channels milled in the capillary channel. The micro channels fills fast by capillary force and then promote the filling of the rest of the channel.

### CONCLUSION

The corona treatment is highly preferable to get the collection chamber filled with plasma.

The use of micro channels decreases the filling time.

1-22. (canceled)

23. A device for separating a suspension comprising 200 μl or less into a liquid phase and a retentate phase, said device comprising a separation chamber (2) comprising an application zone (1) and a hydrophilic filter material (17), said separation chamber being connected to a first capillary channel (3), wherein the connecting junction between the separation chamber and the first capillary channel comprises a physical barrier (10) preventing flow of residue retentate from a lower part of the chamber into the first capillary channel, wherein the physical barrier (10) in a horizontal plane and in a direction towards the first capillary channel describes an incline extending from a bottom of the separation chamber.

24. The device according to claim 23, wherein an incline in vertical direction is 0.2-1.6 mm, and in the horizontal direction 0-100% of the length of the first capillary channel.

25. The device according to claim 24, wherein the incline in vertical direction is about 0.8-1.6 mm, and in the horizontal direction about 20-80% of the length of the first capillary channel.

26. The device according to claim 23, wherein at least a lower part of an internal surface of the first capillary channel facing the liquid is made of a surface treated plastic material.

27. A device according to claim 26, where the surface treated plastic material is polystyrene, polymethylmethacrylate, polyethylene, polypropylene, polyacrylates, silicon elastomers or the like.

28. The device according to claim 23, where the surface treatment is an oxidation.

29. The device of claim 28, wherein the oxidation is a corona treatment.

30. A device according to claim 23, further comprising a collecting chamber (4a) connected to the first capillary channel.

31. A device according to claim 23, further comprising an upper part and a lower part, wherein the two parts when assembled form the separation chamber, said upper part having an inlet leading to the separation chamber.

32. A device according to claim 23, wherein interfaces between the upper and lower parts are sealed with a hydrophobic sealant.

33. A device according to claim 23, further comprising a prefilter material (15).

34. A device according to claim 23, where a width and height of the first capillary channel is 0.25-2.0 mm and 0.2-1.0 mm, respectively.

35. A device according to claim 23, where a length of the first capillary channel from an outlet of the separation chamber to the inlet of collection chamber is 5-20 mm.

36. Use of a device according to claim 23, for separating a suspension comprising 200 μl or less into a liquid phase and a retentate phase, wherein the liquid phase is substantially free of suspended matter.

37. Use according to claim 36, wherein the suspension is blood.

38. A method for separating a liquid sample consisting of less than 200 μl suspension, into a retentate phase comprising the suspended matter, and a liquid phase substantially free of suspended matter; the method comprising the steps of:
a. optionally applying a suspension to a prefilter and leading the suspension through the prefilter for the retention of suspended matter and substantially uniform transfer the liquid to the filter material of step b;
b. applying less than 200 μl of a sample suspension, or the liquid of step a., to a filter material;
c. applying the filter material comprising the suspension to a separation chamber, which is connected to a first capillary channel;
d. over saturating the filter to feed the first capillary channel;
e. sedimenting the suspended matter on a lower part of the separation chamber to separate the suspension into the retentate phase and the liquid phase, thereby preventing flow of residue retentate from the lower part of the separation chamber into the first capillary channel; and
f. directing the liquid phase into the first capillary channel.

39. A method according to claim 38, where the liquid phase is directed into the first capillary channel solely by combined action of capillary forces provided by the first capillary channel and hydrostatic pressure generated by the applied sample.

40. A method according to claim 38, wherein the liquid is human blood.
